(19) United States
(12) Patent Application Publication
(10) Pub. No.: US 2009/0073362 A1
(43) Pub. Date: Mar. 19, 2009

(54) LIQUID CRYSTAL DEVICE AND ELECTRONIC APPARATUS

(75) Inventor: Nobukazu NAGAE, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/212,112

(22) Filed: Sep. 17, 2008

(30) Foreign Application Priority Data
Sep. 18, 2007 (JP) 2007-241019

(51) Int. Cl. G02F 1/1337

(52) U.S. Cl. 349/128

(57) ABSTRACT

A liquid crystal device includes: a first substrate; a second substrate; and a liquid crystal layer interposed between the first and second substrates, the layer being made of liquid crystal aligned vertically in an initial alignment state and exhibiting negative dielectric anisotropy. The first substrate includes a plurality of pixel electrodes and a first alignment layer composed of a vertical alignment layer provided on the pixel electrodes and of a horizontal alignment layer provided in a region on the pixel electrodes and the first substrate, the region excluding the pixel electrodes. The second substrate includes an electrode, a protrusion provided so as to face the horizontal alignment layer, and a second alignment layer made of a vertical alignment layer provided on the electrode and the protrusion.

### BACKGROUND

1. Technical Field

The present invention relates to a liquid crystal device and an electronic apparatus.

2. Related Art

Liquid crystal devices are used in equipment such as liquid crystal projectors for displaying images on a large screen. Projectors are expected to provide high brightness and contrast. In recent years, a vertical alignment mode is being employed as a liquid crystal alignment mode for a liquid crystal device for projectors, since the vertical alignment mode allows high contrast display.

However, in the vertical alignment mode, the liquid crystal stands orthogonal to a substrate surface and has poor interaction in an azimuth direction of falling during application of voltage. Moreover, upon application of voltage, an electric field in a lateral direction parallel to the substrate surface is generated from an end of a pixel electrode. This electric field in the lateral direction causes the liquid crystal to fall in different directions, thereby developing disclination. With the development of disclination, display defects such as brightness irregularity, lower contrast, and afterimages become visible.

In order to uniaxially align liquid crystal of a vertically aligned liquid crystal display element during application of voltage, techniques such as follows are disclosed. For example, JP-A-2001-343651 proposes a method for unidirectionally aligning liquid crystal molecules in a pixel section of a liquid crystal device during application of voltage, by providing a vertical alignment regulating region inside the pixel section and an alignment regulating region outside the pixel section. Similarly, a liquid crystal device is proposed in JP-A-2005-107373, in that: an inorganic alignment layerlayer is produced through an oblique vapor deposition technique; the thickness of the produced layerlayer is varied between a display region and a non-display region so as to regulate a pre-tilt angle of the inorganic alignment layer; and vertically aligned liquid crystal in the display region falls in one direction upon application of voltage.

Regarding these techniques, FIG. 14 illustrates a case in which, in a vertically aligned liquid crystal device having regions of a hybrid alignment nematic (HAN) mode around pixel electrodes 9, liquid crystal molecules in these regions (above the pixel electrodes 9) may tilt under the influence of liquid crystal molecules that align horizontally in these regions when a voltage is not being applied. This may cause light leakage during a black display and thereby decrease contrast.

### SUMMARY

An advantage of the invention is to provide a liquid crystal device and an electronic apparatus having the liquid crystal device, the device being such that, during application of no voltage, a HAN alignment region is suppressed from influencing a vertical alignment region adjacent to the HAN alignment region so as to prevent the alignment disorder of the liquid crystal molecules and to perform a high-contrast, black display with no light leakage.

According to a first aspect of the invention, a liquid crystal device includes: a first substrate; a second substrate; and a liquid crystal layer interposed between the first and second substrates, the layer being made of liquid crystal aligned vertically in an initial alignment state and exhibiting negative dielectric anisotropy, in that: the first substrate includes a plurality of pixel electrodes and a first alignment layer composed of a vertical alignment layer provided on the pixel electrodes and of a horizontal alignment layer provided in a region on the pixel electrodes and the first substrate, the region excluding the pixel electrodes; and the second substrate includes an electrode, a protrusion provided so as to face the horizontal alignment layer, and a second alignment layer made of a vertical alignment layer provided on the electrode and the protrusion.

In the display of this aspect of the invention, the liquid crystal exhibits vertical alignment in a region (a pixel section) of the pixel electrodes that perform a display and exhibits alignment of a hybrid alignment nematic (HAN) mode in a region at the periphery of each pixel electrode (a peripheral section).

In this aspect of the invention, because the protrusion is provided to each region of the HAN mode on a side adjacent to the second substrate, the thickness of the liquid crystal layer of the HAN alignment region becomes thinner than when the protrusion is not provided. It therefore becomes possible to suppress the liquid crystal layer in the HAN alignment region from influencing the vertically aligned liquid crystal molecules lying adjacent to the HAN alignment region. In other words, as the alignment disorder of the liquid crystal is reduced at the boundary between each vertical alignment region (the pixel section) and each HAN alignment region (the peripheral section), it becomes possible to provide a black display with hardly any light leakage in the vertical alignment region (the pixel section) during application of no voltage. As a result, the liquid crystal device having the vertical alignment regions and the HAN alignment regions may perform a high-contrast display with deep black.

It is preferable that a height of the protrusion be less than 40% of a thickness of the liquid crystal layer on the pixel electrodes.

In this case, if the height of the protrusion is 40% or more of the thickness of the liquid crystal layer, the liquid crystal molecules tend to align in accordance with the configuration of the sidewall of the protrusion. Thus, it is necessary to keep the height of the protrusion less than 40% of a cell gap.

It is preferable that a width of a tip surface of the protrusion be equal to or wider than a width of the horizontal alignment layer.

In this case, the thickness of the liquid crystal layer in the entire HAN alignment region can be made thin. It is therefore possible to suppress the horizontally aligned liquid crystal molecules in the HAN alignment region from affecting the alignment of the liquid crystal molecules in the vertical alignment region adjacent to the HAN alignment region.

It is preferable that the protrusion be provided in a light shielding region provided at a periphery of each pixel electrode.

In this case, light leakage during the black display may be successfully reduced.

It is preferable that the protrusion be made of a resist.

In this case, it is possible to use, as the protrusion, a resist mask which is used for pattern formation of a light shielding layer provided to the second substrate and to readily produce the protrusion at low costs.

It is preferable that the liquid crystal device further include: a pair of ¼ wavelength plates disposed outside the first and second substrates, and a polarizing plate disposed outside the pair of ¼ wavelength plates.

In this case, because a double refraction effect may be exerted regardless of the azimuth direction (azimuth angle) of the liquid crystal molecules, it is possible to greatly improve brightness of the liquid crystal device.

According to a second aspect of the invention, an electronic apparatus includes the liquid crystal device.

The liquid crystal device of the first aspect of the invention is applicable to display screens of electronic apparatuses such as liquid crystal televisions and mobile phones, monitors of personal computers, and optical modulating devices of liquid crystal projectors. By using the liquid crystal device for such applications, it becomes possible to provide the electronic apparatus having excellent display characteristics.

### BRIEF DESCRIPTION OF THE DRAWINGS

The invention will be described with reference to the accompanying drawings, wherein like numbers reference like elements.

FIG. 1 is an equivalent circuit schematic of a switching element, signal line, etc. of a liquid crystal device according to a first embodiment.

FIG. 2 is a plan diagram showing the structure of a group of neighboring pixels of a TFT array substrate of the liquid crystal device of FIG. 1.

FIG. 3 is a sectional diagram showing the composition of the elements of the liquid crystal device of FIG. 1.

FIG. 4 is a sectional pattern diagram showing the structures of a pixel section and a peripheral section of the liquid crystal device of FIG. 1.

FIG. 5 is a pattern diagram to explain the alignment state of liquid crystal of the liquid crystal device of the embodiment during application of no voltage.

FIG. 6 is a graph showing light transmissivity in the liquid crystal device (near a pixel) during application of no voltage.

FIG. 7 is a sectional pattern diagram showing a liquid crystal device according to a second embodiment.

FIGS. 8A and 8B are diagrams showing the positions of optical axes of ¼ wavelength plates and polarizing plates.

FIG. 9 is a perspective diagram showing director distribution of liquid crystal molecules on a pixel electrode of a liquid crystal display element of the embodiment of the invention, upon application of voltage to only one pixel (simulation).

FIG. 10 is a diagram showing a light transmission state in one pixel during application of voltage under a condition that the ¼ plates are not inserted to both sides of the liquid crystal display element.

FIG. 11 is diagram showing a light transmission state of one pixel during application of voltage under a condition that the ¼ plates are inserted to both sides of the liquid crystal display element.

FIGS. 12A through 12C are perspective diagrams showing some examples of an electronic apparatus according to one embodiment of the invention.

FIG. 13 is a diagram showing an example of a projection type display according to the embodiments of the invention.

FIG. 14 is a pattern diagram to explain an alignment state of liquid crystal of a related-art liquid crystal device during application of no voltage.

### DESCRIPTION OF EXEMPLARY EMBODIMENTS

Embodiments of the invention will now be described with reference to the drawings. The scales of the layers and members in the drawings differ from each other so as to make each layer and member be recognizable in each drawing.

### First Embodiment of Liquid Crystal Device

The liquid crystal device of the present embodiment is a transmissive liquid crystal device of an active matrix type using thin-layer transistors as switching elements.

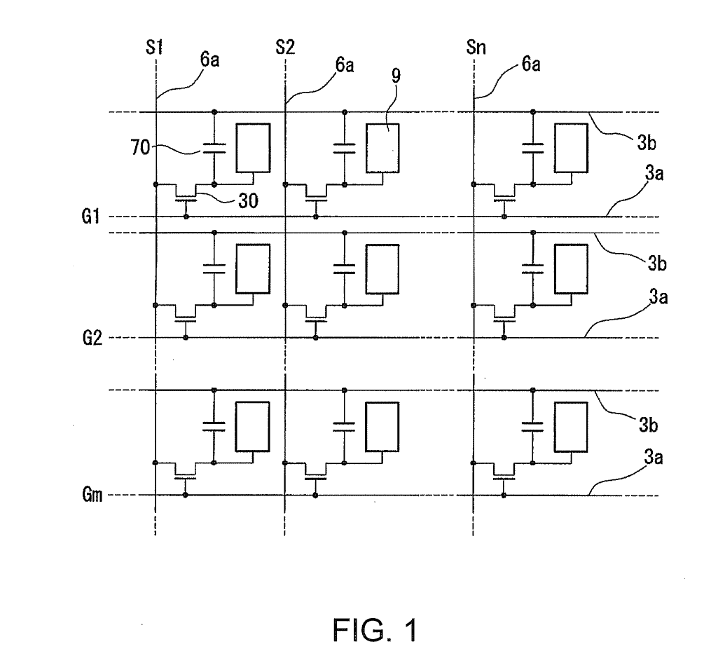

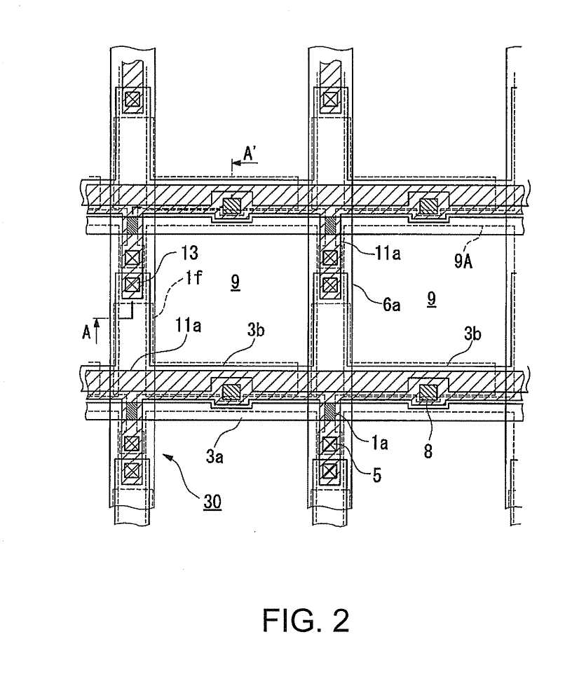

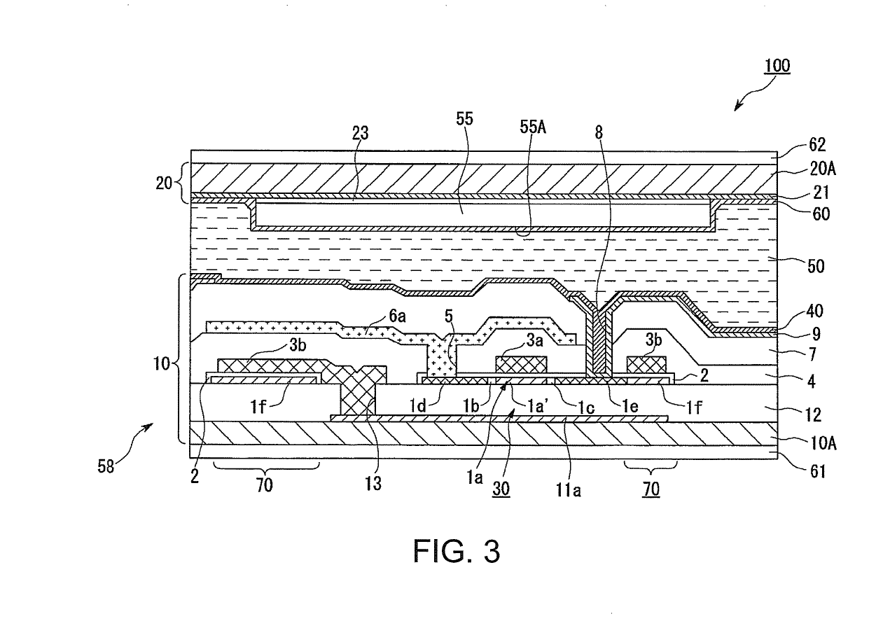

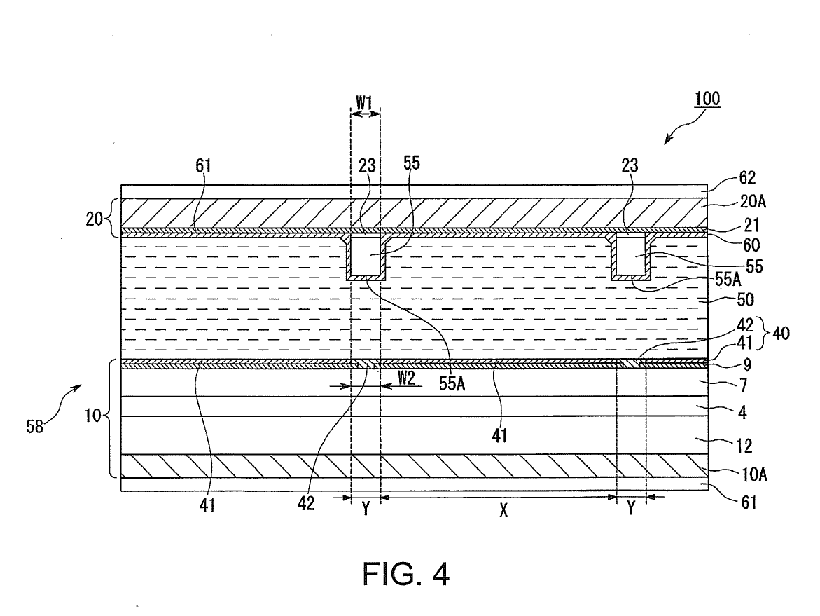

FIG. 1 is an equivalent circuit schematic of the switching elements, signal lines, etc. of a plurality of pixels constituting an image display region of the transmissive liquid crystal device according to the embodiment. The plurality of pixels are arranged in a matrix, constituting an image display region of the liquid crystal device. FIG. 2 is a plan diagram showing the structure of a group of neighboring pixels of a TFT array substrate having data lines, scanning lines, pixel electrodes, etc. FIG. 3 is a sectional diagram, taken on an A-A′ line of FIG. 2, showing element regions of the transmissive liquid crystal device of the embodiment. FIG. 4 is a sectional pattern diagram of the plurality of pixels of the transmissive liquid crystal device according to the embodiment. In FIGS. 3 and 4, the upper side of each drawing is a side of light incidence, and the lower side is a viewing side (a side of an observer).

In the transmissive liquid crystal device of the embodiment, with reference to FIG. 1, each of the plurality of pixels arranged in the matrix and constituting the image display region includes a pixel electrode 9 and a TFT element 30. The TFT element 30 is the switching element for controlling power to be supplied to the pixel electrode 9. Each data line 6a for receiving an image signal is electrically coupled the source of each TFT element 9. Image signals S1, S2, . . . Sn to be written in the data lines 6a are supplied line-sequentially in this order or supplied in groups to the plurality of neighboring data lines 6a.

Each scanning line 3a is electrically coupled to the gate of each TFT element 30. Scanning signals G1, G2, . . . Gm are line-sequentially applied in pulse to a plurality of scanning lines 3a in a predetermined timing. Each pixel electrode 9 is electrically coupled to the drain of each TFT element 30. When the TFT element 30 which is the switching element is turned on for a certain period of time, the pixel electrode 9 writes in the image signals S1, S2, . . . Sn supplied from the data line 6a in a predetermined timing.

The image signals S1, S2, . . . Sn of predetermined levels that are written in the liquid crystal through the pixel electrodes 9 are held for a certain period of time between the pixel electrodes 9 and a common electrode which will be described hereafter. Since the alignment and order of molecular aggregates of liquid crystal change in accordance with the levels of voltage applied, the liquid crystal modulates light and thus enables gradation display. In addition, in order to prevent the held image signals from leaking, an accumulation capacitance 70 is provided in parallel to a liquid crystal capacitance which is provided between the pixel electrode 9 and the common electrode.

With reference to FIG. 2, a plan structure of the transmissive liquid crystal device of the embodiment will now be described. Referring to FIG. 2, provided in the matrix on the TFT array substrate are the plurality of rectangular pixel electrodes 9 (outlined by section 9A in dotted lines) made of a transparent conductive material such as indium tin oxide (hereunder abbreviated as ITO). The data lines 6a, scanning lines 3a, and capacitance lines 3b are provided along vertical and horizontal boundaries of the pixel electrodes 9. In this embodiment, a pixel represents a region which includes each pixel electrode 9, data line 6a, scanning line 3a, capacitance line 3b, and the like that surround the pixel electrode 9. Each pixel, out of the plurality of pixels arranged in the matrix, is composed such that each pixel can perform the display.

Particularly, in this embodiment, a region on the pixel electrode 9 of a pixel that allows transmission of a display light is defined as a “pixel section,” and a region in the periphery of the pixel section that shields light is defined as a “peripheral region.”

The data line 6a is electrically coupled via a contact hole 5 to a source region (to be described) in a semiconductor layer 1a which is made of e.g. polysilicon layer and constitutes the TFT element. The pixel electrode 9 is electrically coupled via a contact hole 8 to a drain region (to be described) in the semiconductor layer 1a. Also, the scanning line 3a, which is arranged opposite from a channel region (a region with diagonal left-up lines, to be described) in the semiconductor layer 1a, operates as a gate electrode at a part opposite from the channel region.

The capacitance line 3b includes: a main line section extending substantially linearly along the scanning line 3a (i.e., a first region provided along the scanning line 3a in plan view), and a protruded section protruding along the data line 6a from a point of intersection with the data line 6a to a side adjacent to a preceding stage (upward in the drawing) (i.e., a second region extending along the data line 6a in plan view). Referring to FIG. 2, regions with diagonal right-up lines include a plurality of first light shielding layers 11a.

Referring to FIGS. 3 and 4, the structure of a section of the transmissive liquid crystal device of the embodiment will now be described. In FIG. 4, some constituting elements such as the switching element are omitted for legibility of the drawing. Referring to FIGS. 3 and 4, a transmissive liquid crystal device 100 of the embodiment includes: a TFT array substrate (a first substrate) 10, a counter substrate (a second substrate) 20 disposed opposite from the TFT array substrate 10, and a liquid crystal layer 50 disposed between the TFT array substrate 10 and the counter substrate 20. The liquid crystal layer 50 is made of liquid crystal aligned vertically in the initial alignment state and exhibiting negative dielectric anisotropy. Thus, this transmissive liquid crystal device 100 is a display of a vertical alignment mode having hybrid aligned nematic (HAN) alignment regions around the pixel regions.

The TFT array substrate 10 is mainly composed of: a substrate body 10A made of a light transmissive material such as quartz, pixel electrodes 9 provided on the surface of the substrate body 10A on a side adjacent to the liquid crystal layer 50, and an alignment layer 40. The counter substrate 20 is mainly composed of: a substrate body 20A made of a light transmissive material such as glass or quartz, a common electrode 21 provided on the surface of the substrate body 20A on a side adjacent to the liquid crystal layer 50, an alignment layer 60, and a protrusion 55 disposed on the common electrode 21.

Also, referring to FIG. 3, the TFT array substrate 10 is provided with: the pixel electrodes 9 on the surface of the substrate body 10A on the side adjacent to the liquid crystal layer 50, and TFT elements 30 provided adjacent to the pixel electrodes 9 to switch and control the pixel electrodes 9.

Each TFT element 30 has a lightly doped drain (LDD) structure and includes: the scanning line 3a, a channel region 1a′ of the semiconductor layer 1a in which a channel is generated by an electric field from the scanning line 3a, a gate insulating layer 2 which insulates the scanning line 3a from the semiconductor layer 1a, the data line 6a, a low-concentration source region 1b and a low-concentration drain region 1c of the semiconductor layer 1a, and a high-concentration source region 1d and a high-concentration drain region 1e of the semiconductor layer 1a.

The substrate body 10 having the scanning line 3a and the gate insulating layer 2 includes a second interlayer insulating layer 4. The second interlayer insulating layer 4 is opened at the contact hole 5 communicating with the high-concentration source region 1d and at the contact hole 8 communicating with the high-concentration source region 1e. That is, the data line 6a is electrically coupled to the high-concentration source region 1d via the contact hole 5 penetrating the second interlayer insulating layer 4. Also, provided on the data line 6a and the second interlayer insulating layer 4 is a third interlayer insulating layer 7 opened at the contact hole 8 communicating with the high-concentration drain region 1e. In other words, the high-concentration drain region 1e is electrically coupled to the pixel electrode 9 via the contact hole 8 penetrating the second and third interlayer insulating layers 4 and 7.

Also, in the embodiment, the accumulation capacitance 70 includes: the gate insulating layer 2 extended from a position opposite from the scanning line 3a and used as a dielectric layer, a first accumulation capacitance electrode if made by extending the semiconductor layer 1a, and a second accumulation capacitance electrode made of a part of the capacitance line 3b opposite from the gate insulating layer 2 and first accumulation capacitance electrode 1f.

In a region having the TFT element 30 on the surface of the substrate body 10A on the side adjacent to the liquid crystal layer 50 of the TFT array substrate 10, each first light shielding layer 11a is provided. The first light shielding layer 11a operates such that, when light transmitted through the TFT array substrate 10 is reflected at a lower surface (as viewed in the drawing) of the TFT array substrate 10 (at an interface between the TFT array substrate 10 and air) and returns to the side adjacent to the liquid crystal layer 50, this first light shielding layer 11a prevents the returned light from entering into at least the channel region 1a′ and the low-concentration source and drain regions 1b and 1c of the semiconductor layer 1a. Provided between the first light shielding layer 11a and the TFT element 30 is a first interlayer insulating layer 12 that electrically insulates the semiconductor layer 1a constituting the TFT element 30 from the first light shielding layer 11a. In addition, with reference to FIG. 2, the first light shielding layer 11a provided to the TFT array substrate 10 is electrically coupled to the capacitance line 3b in a preceding or post stage via a contact hole 13.

Also, referring to FIG. 4, the alignment layer 40 (first alignment layer) is provided on the TFT array substrate 10 on the side adjacent to the liquid crystal layer 50, specifically, on the pixel electrode 9 and the third interlayer insulating layer 7. The alignment layer 40 regulates the alignment of liquid crystal molecules in the liquid crystal layer 50 during application of no voltage and has an alignment function that is different in each predetermined region, with reference to FIG. 4.

Specifically, the alignment layer 40 is composed of: a vertical alignment layer 41 provided in a pixel section X which is a region mainly including the pixel electrode 9, and a horizontal alignment layer 42 provided in a peripheral section Y which provides boundaries to the pixel section X. More specifically, the horizontal alignment layer 42 is provided to the peripheral section Y (a light shielding region: a non-display region constituted of a region not having the pixel electrode 9 and of peripheries of the pixel electrode 9), and the vertical alignment layer 41 is provided to the pixel region X (a transmissive region: a display region surrounded by the light shielding region having the horizontal alignment layer 42).

With this structure, the liquid crystal of the pixel section X aligns vertically to the substrate 10 mainly based on the vertical alignment layer 41, while the liquid crystal of the peripheral section Y uniaxially aligns substantially horizontally to the substrate 10 mainly based on the horizontal alignment layer 42. Additionally, the horizontal alignment layer 42 has a function to align (pre-tilt) the liquid crystal to a predetermined azimuth angle and is made of a polyimide layer that was subjected to a rubbing treatment.

The vertical alignment layer 41 is provided by bringing an exposed surface of the pixel electrode 9 of the TFT array substrate 10 into contact with steam of e.g. an octadencyltrimethoxysilane (ODS) solution. A long-chain alkyl group of an ODS molecule, which has an inorganic reactive group, does not combine with an organic material of the horizontal alignment layer 42 but is selectively coupled onto the pixel electrode 9 made of ITO that is an inorganic material. Therefore, the vertical alignment layer 41 is selectively provided at a portion on the pixel electrode 9 that is exposed between the horizontal alignment layers 42.

In contrast, provided on substantially the entire surface of the substrate body 20A of the counter substrate 20 on the side adjacent to the liquid crystal layer 50 is the common electrode 20 made of e.g. ITO.

Provided also on the substrate body 20A on the side adjacent to the liquid crystal layer 50 are the data line 6a, the scanning line 3a, and a second light shielding layer 23. The second light shielding layer 23 is provided in a region opposite from the region for forming the TFT element 30, namely, in each peripheral section Y, in order to prevent the incident light from entering into the channel region 1a′, the low-concentration source region 1b, and the low-concentration drain region 1c of the semiconductor layer 1a of the TFT element 30.

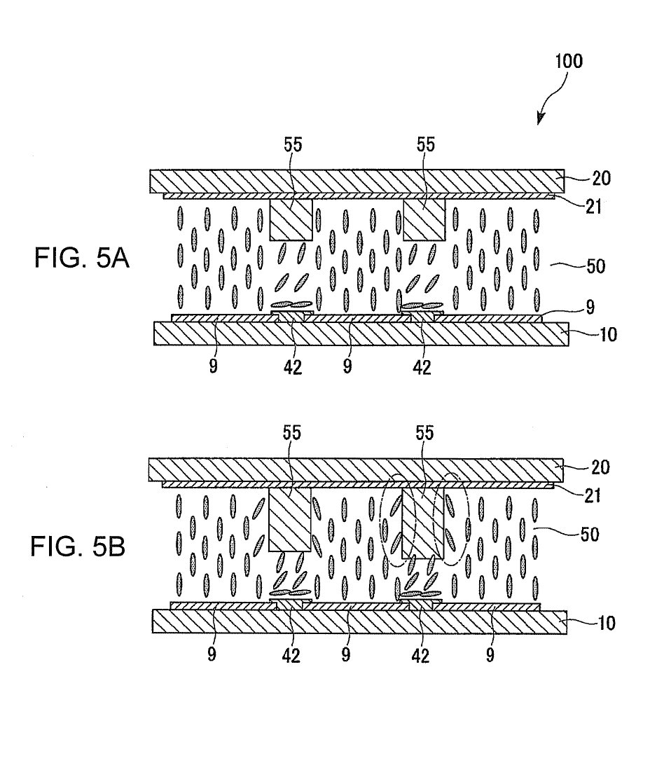

The protrusion 55 is formed in height of equal to or less than 40% of the cell gap. If the height of the protrusion 55 exceeds 40% of the cell gap, the liquid crystal molecules align against the side surface of the protrusion 55 and, with reference FIG. 5B, align radially around the protrusion 55 on the plan surface of the pixel. Thus, it is preferable that the height of the protrusion 55 be 40% or lower than that of the cell gap.

On the common electrode 21 on the side adjacent to the liquid crystal layer 50, the alignment layer 60 (second alignment layer) is provided covering the exposed surface of the common electrode 21 and the surface of the protrusion 55. Different from the alignment layer 40 provided on the side adjacent to the TFT array substrate 10, the alignment layer 60 is constituted only of a vertical alignment layer. Specifically, the alignment layer 60 (hereunder possibly referred to as the vertical alignment layer 60) is formed similarly to the vertical alignment layer 41, that is, by coupling the long-chain alkyl group of the octadencyltrimethoxysilane (ODS) molecule onto the common electrode 21 and the protrusion 55, except that the rubbing treatment was not conducted. The vertical alignment layer 60 is provided on the entire exposed surface of the common electrode 21 and the entire surface of the protrusion 55, because the long-chain alkyl group of the ODS molecule combines with the common electrode 21 made of ITO that is the inorganic material and with the protrusion 55 made of a resist.

The TFT array substrate 10 and the counter substrate 20 having such structures are attached to each other with a sealant. A liquid crystal panel 58 is constituted of these substrates 10, 20 and the liquid crystal layer 50 interposed therebetween, and is made of liquid crystal having negative dielectric anisotropy (a negative type liquid crystal material). Also, a pair of polarizing plates 61, 62 are provided in a cross Nicole setting on both sides of the liquid crystal panel 58, and polarization axes 61a, 62a of the respective polarizing plates 61, 62 are substantially orthogonal to each other. Also, a light source unit (not shown) is disposed below the polarizing plate 62. The transmissive liquid crystal device 100 of the embodiment is thus composed.

As described, by providing the protrusion 55 corresponding to the horizontal alignment layer 42 (the second light shielding layer 23) on the side adjacent to the counter substrate 20, the cell gap in the HAN alignment region becomes smaller than that in the vertical alignment region, and the influence on the vertical alignment region lying adjacent to the HAN alignment region decreases during application of no voltage. In other words, with reference to FIG. 5A, a region in which the liquid crystal molecules are horizontally aligned by the horizontal alignment layer 42 becomes compressed by the protrusion 55 in the thickness direction of the liquid crystal layer 50. As a result, it becomes possible to suppress the liquid crystal molecules that align horizontally because of the horizontal alignment layer 42 from influencing on the alignment of the liquid crystal molecules that align vertically because of the vertical alignment layer 41 during application of no voltage. Therefore, it is possible to prevent the liquid crystal molecules in the vertical alignment region from tilting (becoming disorderly aligned) under the influence of the horizontally-aligned liquid crystal molecules in the HAN alignment region, and to thereby acquire substantially vertical alignment during application of no voltage. Thus, the light leakage in the vertical alignment region (the pixel section) during the black display does not occur, and it becomes possible to improve the brightness and contrast of the liquid crystal device 100.

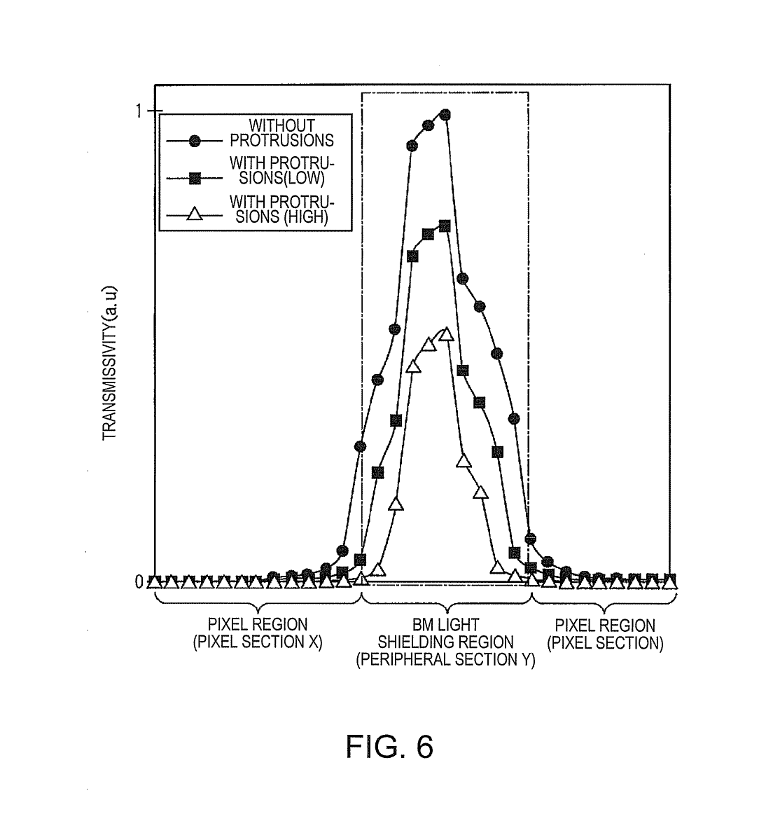

FIG. 6 is a graph showing the light transmissivity in the liquid crystal device during application of no voltage.

Compared herein are three liquid crystal devices with no protrusions, with protrusions (height: low), and with protrusions (height: high).

The graph indicates that the light leakage occurs in the vertical alignment region (the pixel section X) in the device with no protrusions. Also, it was found that the light leakage in the pixel region decreases as the height of the protrusion increases. Thus, under these conditions, it is clear that the protrusion of a predetermined height has the effect of preventing light leakage in the pixel section X.

### Second Embodiment of Liquid Crystal Device

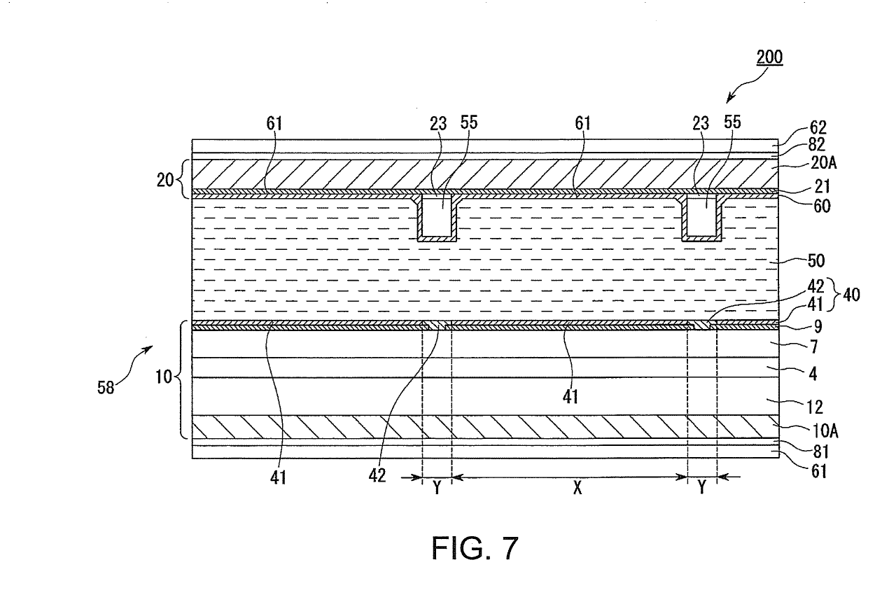

The liquid crystal device according to the second embodiment of the invention will now be described. In this embodiment, descriptions of the reference numbers allotted to the same compositions as those in the first embodiment will not be repeated. FIG. 7 is a sectional pattern diagram showing the liquid crystal device of the present embodiment.

A liquid crystal device 200 according to the second embodiment of the invention differs from that of the first embodiment, in that a pair of ¼ wavelength plates 81, 82 are disposed on both sides of the liquid crystal panel 58 and that the pair of polarizing plates 61, 62 are disposed outside the pair of ¼ wavelength plates 81, 82.

Referring to FIG. 7, the ¼ wavelength plates 81, 82 are arranged, with the liquid crystal panel 58 interposed therebetween, outside the TFT array substrate 10 and the counter substrate 20, respectively. The 4 wavelength plates 81, 82 produce an optical path difference of an approximately 4/1 wavelength between linearly polarized lights of which transmissive axes are orthogonal to each other. Also, the polarizing plates 61, 62 are disposed in the cross Nicole setting on both sides of the ¼ wavelength plates 81, 82.

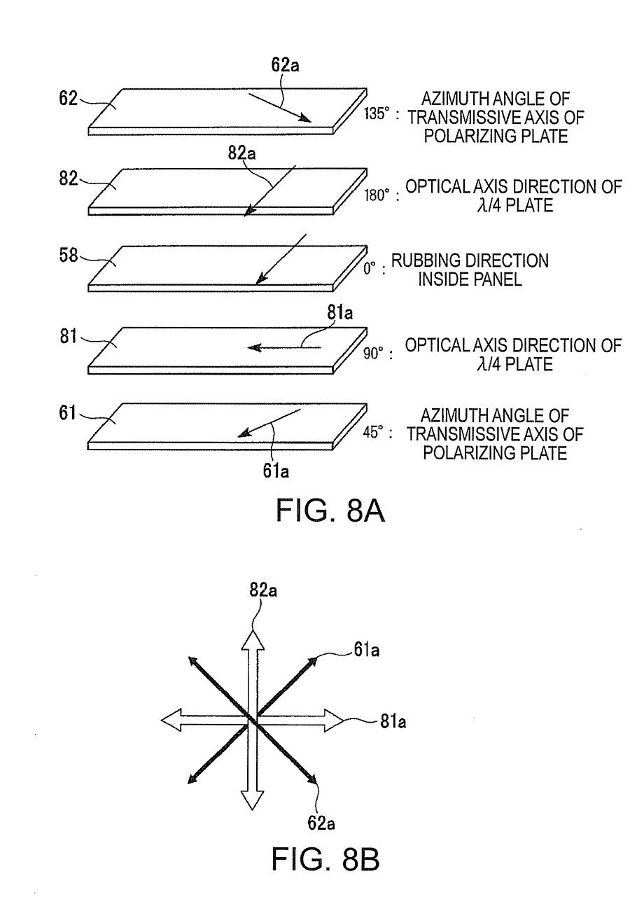

FIGS. 8A and 8B show the positions of the ¼ wavelength plates 81, 82 and the polarizing plates 61, 62. Referring to FIG. 8B, when viewed vertical to the substrate surface, the polarization axis 61a of the polarizing plate 61 and the polarization axis 62a of the polarizing plate 62 are substantially orthogonal to each other. Also, an optical axis (retardation axis) 81a of a ¼ wavelength plate 81 and an optical axis 82a of a ¼ wavelength plate 82 are substantially orthogonal to each other. The angle between the polarization axis 61a and the optical axis 81a and the angle between the polarization axis 62a and the optical axis 82a are both approximately 45°. That is, the polarizing plate 61 and the ¼ wavelength plate 81, and the polarizing plate 62 and the ¼ wavelength plate 82 together constitute a circularly polarizing plate.

### Transmission Simulation of the First Embodiment

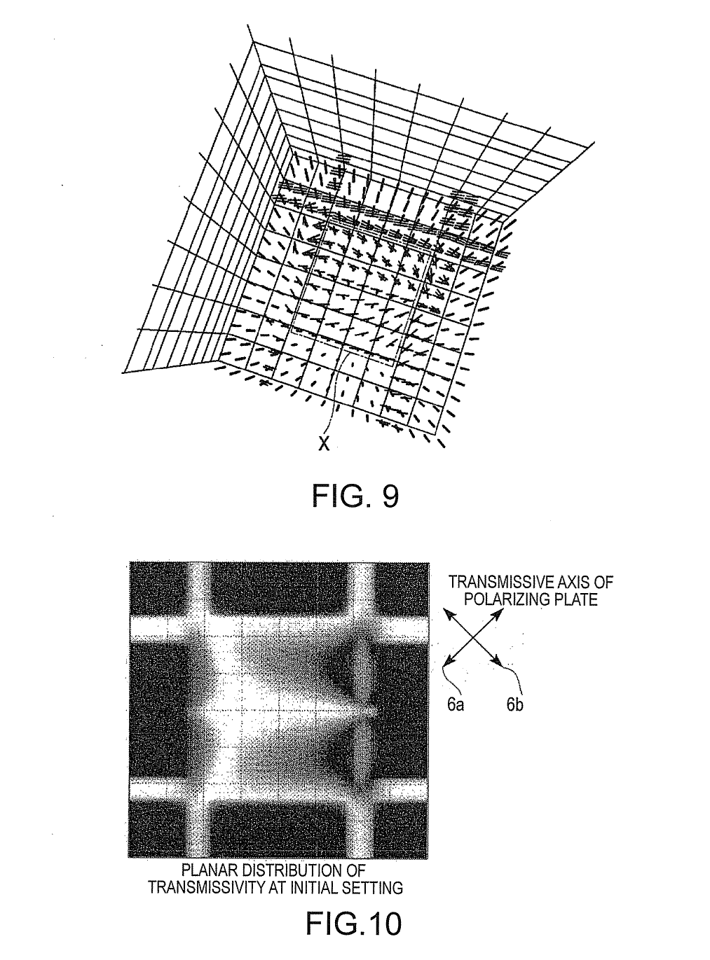

Described below are the results of transmission simulation of the liquid crystal device 100 according to the first embodiment. FIG. 9 is a perspective diagram showing the director distribution of the liquid crystal molecules on a pixel electrode. FIG. 10 shows a state of light transmission in one pixel during application of voltage.

As shown in FIG. 4, light emitted from the light source and transmitted through the polarizing plate 61 and the liquid crystal panel 58, in this order, is emitted from the polarizing plate 62 in the same polarized state as that of the linearly polarized light to which a phase difference of λ/2 was imparted by the liquid crystal panel 58. The liquid crystal molecules, during application of voltage, align in a direction different from a predetermined alignment direction in a correlation with azimuth angle anchoring determined by an electric field at an end of the pixel electrode 9 (pixel section X) and the vertical alignment layer 60 but are in part rotated in the azimuth angle direction (see FIG. 9). Such alignment (azimuth angle direction) of the liquid crystal molecules, when matched with the transmissive axis of either the polarizing plate 61 or 62, decreases the transmissivity at this part.

With the liquid crystal device 100 of the first embodiment, during application of no voltage, it is possible to prevent the horizontally-aligned liquid crystal molecules in the HAN alignment region from influencing the alignment of the liquid crystal molecules in the vertical alignment region lying adjacent to the HAN alignment region. However, it is found that a problem as described above occurs during application of voltage. In order to overcome such a disadvantage, the second embodiment shown below is aimed to prevent the decrease in light transmissivity caused by the azimuth direction of the liquid crystal molecules.

### Transmission Simulation of the Second Embodiment

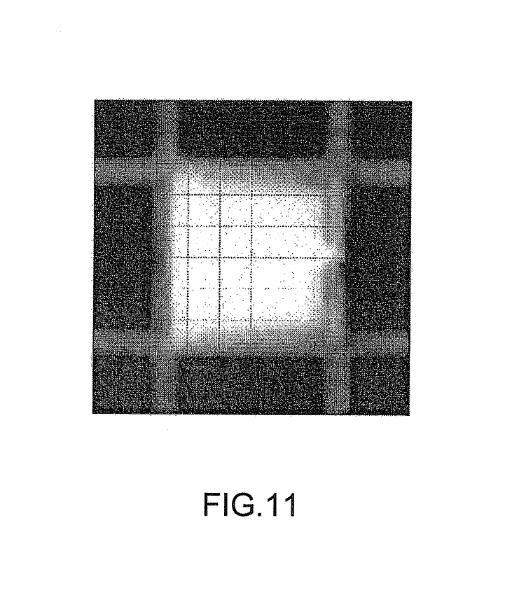

Described below are the results of transmission simulation of the liquid crystal device according to the second embodiment. FIG. 11 shows a light transmission state of one pixel during application of voltage. In the following descriptions, FIGS. 7 and 8A will be referenced when needed.

Referring to FIGS. 7 and 8A, the linearly polarized light emitted from the light source and transmitted through the polarizing plate 61 is converted into a circularly polarized light when given a phase difference of λ/4 by the ¼ wavelength plate 81. The circularly polarized light becomes a reversely-rotated circularly polarized light when given a phase difference of λ/2 by the liquid crystal panel 58. The reversely-rotated circularly polarized light then becomes a linearly polarized light orthogonal to a linearly polarized light that is made incident by the 14 wavelength plate 82 and transmits through the polarizing plate 62.

As described, by providing the ¼ wavelength plates 81, 82 and the polarizers 61, 62 on both sides of the liquid crystal panel 58, it becomes possible to produce the double refraction effect regardless of the azimuth direction (azimuth angle) of the liquid crystal molecules and, thus, to greatly improve the brightness of the liquid crystal device 200.

In the first and second embodiments, the horizontal alignment layer 42 is made of the rubbing-treated polyimide layer in order to provide the layer 42 with the pre-tilt having the azimuth angle. However, the horizontal alignment layer 42 may be an oblique vapor deposition layer made of an inorganic material (inorganic oxide), typically SiO₂, provided by oblique vapor deposition or may be an inorganic alignment layer made also of an inorganic material (inorganic oxide) provided by an ion beam sputtering (IBS) technique.

Described above is the liquid crystal device of one embodiment of the invention. However, the invention is not limited to this embodiment. The invention is not limited to the descriptions of the claims but may be readily modified by those skilled in the art and may also suitably include improvements based on common knowledge of those skilled in the art within the scope of the invention.

For example, although the active matrix type liquid crystal device using the thin-layer transistors is described in the embodiments of the invention, the invention is not limited to this type but is also applicable to an active matrix type liquid crystal device or a passive matrix type liquid crystal device using thin-layer diode (TFD) elements. Moreover, although the transmissive liquid crystal device is described in the embodiments of the invention, the invention is not limited to this type but is also applicable to a reflective or semi-transmissive-reflective liquid crystal device. Thus, the invention is applicable to a liquid crystal device having any structure.

Additionally, in a liquid crystal device having color filters, black masks for separating coloring materials may also operate as the protrusions 55.

Electronic Apparatus

Examples of the electronic apparatus equipped with the liquid crystal device according to the embodiments will now be described.

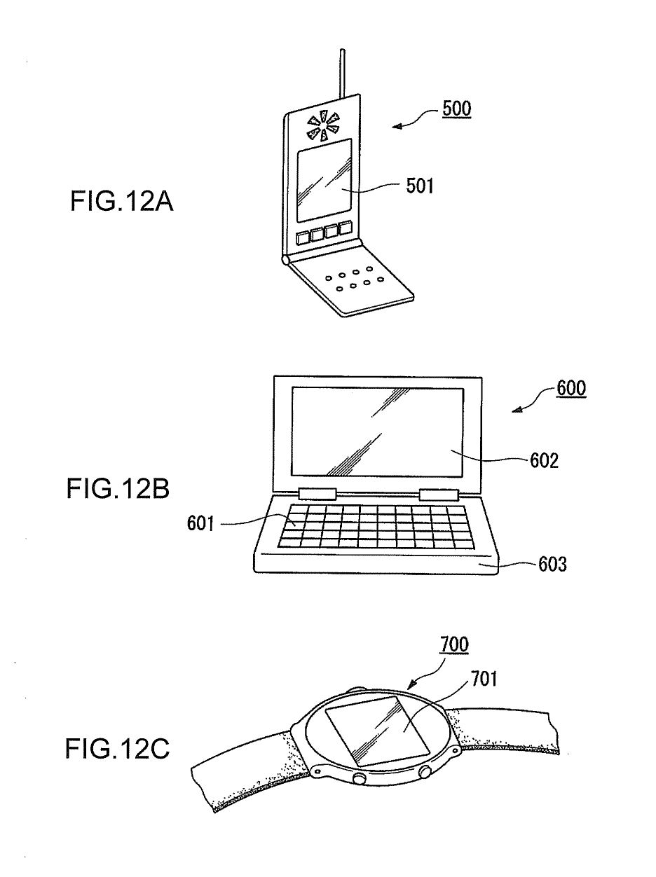

FIG. 12A is a perspective diagram showing an example of a mobile phone. Referring to FIG. 12A, the reference number 500 represents a mobile phone body, and the reference number 501 represents a liquid crystal display section using the liquid crystal device according to the embodiments.

FIG. 12B is a perspective diagram showing an example of a portable type data processing unit such as a word processor and a personal computer. Referring to FIG. 12B, the reference number 600 represents a data processing unit; 601 represents an input section such as a keyboard; 603 represents a data processing unit body; and 602 represents a liquid crystal display section using the liquid crystal device according to the embodiments.

FIG. 12C is a perspective diagram showing an example of a watch-type electronic device. Referring to FIG. 12C, the reference number 700 represents a watch body, and 701 represents a liquid crystal display section using the liquid crystal device according to the embodiments.

As shown, the display sections of the electronic apparatuses in FIGS. 12A through 12C employ the liquid crystal device of the invention. Therefore, the electronic apparatuses become display units that do not create a problem of displaying rubbing stripes caused by a rubbing treatment, for example, but that can maintain a high contrast and high quality display for a long period of time.

Projection Type Display

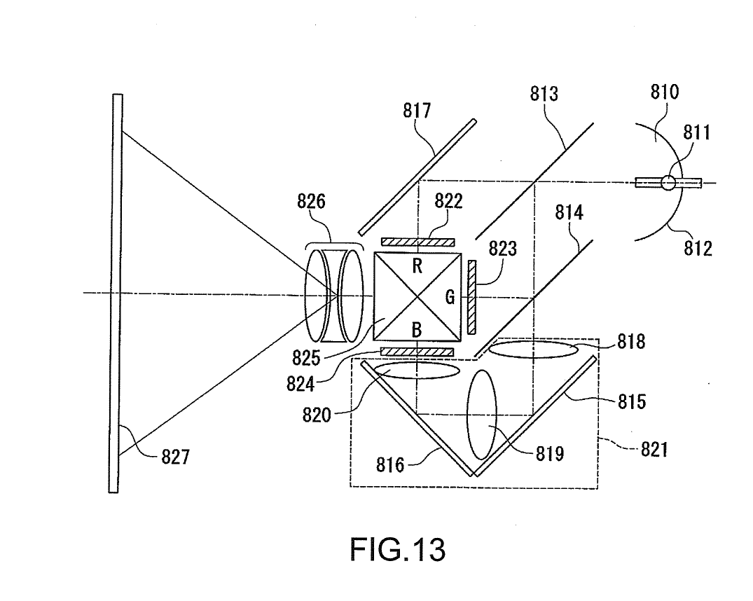

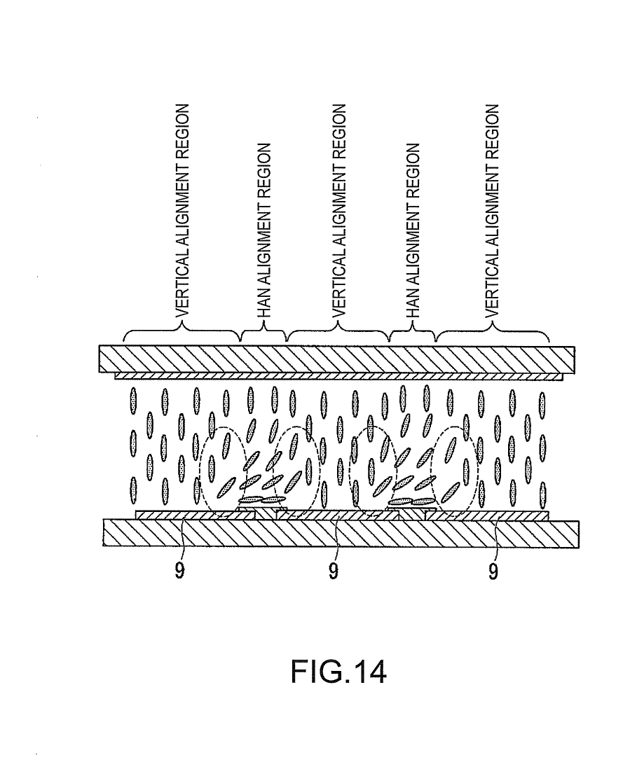

Described with reference to FIG. 13 is a projection type display (a projector) equipped with the liquid crystal device according to the embodiments as an optical modulating means. FIG. 13 is a diagram schematically showing the structure of an essential portion of the projection type display which uses the liquid crystal device according to the embodiments as the optical modulating device. Referring to FIG. 13, the reference number 810 is a light source; 813, 814 are dichroic mirrors; 815, 816, 817 are reflecting mirrors; 818 is an incident lens; 819 is a relay lens; 820 is an emission lens; 822, 823, 824 are liquid crystal optical modulating devices; 825 is a cross dichroic prism; and 826 is a reflection lens.

The light source 810 is composed of a lamp 811, such as a metal halide lamp, and a reflector 812 that reflects light of the lamp. The dichroic mirror 813 for reflecting blue and green light components transmits a red light component out of beams of light from the light source 810, while reflecting the blue and green light components. The transmitted red light component is reflected on the reflecting mirror 817 and made incident on the liquid crystal optical modulating device 822 for red light which is equipped with the liquid crystal device of the invention.

In contrast, the green light component out of the color light components reflected by the dichroic mirror 813 is reflected on the reflecting mirror 814 for green light and made incident on the liquid crystal optical modulating device 823 for green light. The blue light component, on the other hand, transmits also through the secondary dichroic mirror 814. Provided for the blue light component is a light guide means 821 composed of a relay lens system including the incident lens 818, the relay lens 819, and the emission lens 820 in order to compensate the difference in optical path length from those of the green and red light components. Through this light guide means 821, the blue light component is made incident on the liquid crystal optical modulating device 824 for blue light which is equipped with the liquid crystal device of the invention.

The three color light components modulated by the respective light modulating devices enter the cross dichroic prism 825. This prism is composed of four right angle prisms attached to each other and includes, in the inner surface thereof, a dielectric multilayered layer for reflecting red light component and a dielectric multilayered layer for reflecting blue light component that together form a cross shape. The three color light components are synthesized by these dielectric multilayered layers, thereby producing light that displays a color image. The synthesized light is projected on a screen 827 using the projection lens 826 that is a projection optical system and displayed as an enlarged image.

The projection type display having such a structure includes the liquid crystal device of the invention and, thus, becomes a display that does not create a problem of displaying the rubbing stripes caused by the rubbing treatment, for example, but that can maintain a high contrast and high quality display for a long period of time.

What is claimed is:

1. A liquid crystal device, comprising:
a first substrate;
a second substrate; and
a liquid crystal layer interposed between the first and second substrates, the layer being made of liquid crystal aligned vertically in an initial alignment state and exhibiting negative dielectric anisotropy, wherein:
the first substrate includes:
a plurality of pixel electrodes; and
a first alignment layer composed of a vertical alignment layer provided on the pixel electrodes and of a horizontal alignment layer provided in a region on the pixel electrodes and the first substrate, the region excluding the pixel electrodes; and
the second substrate includes:
an electrode;
a protrusion provided so as to face the horizontal alignment layer; and
a second alignment layer made of a vertical alignment layer provided on the electrode and the protrusion.

2. The liquid crystal device according to claim 1, wherein a height of the protrusion is equal to or less than 40% of a thickness of the liquid crystal layer on the pixel electrodes.

3. The liquid crystal device according to claim 1, wherein a width of a tip surface of the protrusion is equal to or wider than a width of the horizontal alignment layer.

4. The liquid crystal device according to claim 1, wherein the protrusion is provided in a light shielding region provided at a periphery of each pixel electrode.

5. The liquid crystal device according to claim 1, the protrusion is made of a resist.

6. The liquid crystal device according to claim 1, further comprising:
a pair of ¼ wavelength plates disposed outside the first and second substrates; and
a polarizing plate disposed outside the pair of ¼ wavelength plates.

7. An electronic apparatus having the liquid crystal device according to claim 1.
